(19) United States
(12) Patent Application Publication
(10) Pub. No.: US 2015/0317018 A1
(43) Pub. Date: Nov. 5, 2015

(54) SHIFT REGISTER ADAPTABLE TO A GATE DRIVER

(71) Applicant: HIMAX TECHNOLOGIES LIMITED, Tainan City (TW)

(72) Inventors: TZU-TSAI LIN, Tainan City (TW); YAW-GUANG CHANG, Tainan City (TW)

(73) Assignee: HIMAX TECHNOLOGIES LIMITED, Tainan City (TW)

(21) Appl. No.: 14/266,624

(22) Filed: Apr. 30, 2014

(51) Int. Cl. G06F 3/041; G09G 3/36

(52) U.S. Cl. CPC G06F 3/0412; G09G 3/3655; G09G 2300/0819; G09G 2300/0876; G09G 2310/0286; G09G 2300/0426

(57) ABSTRACT

A shift register adaptable to a gate driver includes a plurality of active latches and inactive latches, which are connected in cascade. At least one inactive latch is disposed between two adjacent active latches, and each said active latch has its output signal configured as a gate control signal to control a display panel, while an output signal of each said inactive latch is not coupled to the display panel.

### BACKGROUND OF THE INVENTION

1. FIELD OF THE INVENTION

The present invention generally relates to a gate driver adaptable to a display panel, and more particularly to a shift register of a gate driver adaptable to a liquid crystal display panel.

2. DESCRIPTION OF RELATED ART

Touch screens, as input/output devices that adopt sensing technology and display technology, have been widely employed in electronic devices such as portable or hand-held electronic devices.

A touch screen is composed of a display panel and a touch panel. The touch panel may be disposed on the display panel, or may even be integrated within the display panel to form an in-cell touch screen. The in-cell touch screen has thinner form factors than conventional touch screens. However, the touch sensing in the in-cell touch screen may be liable to interference caused by gate driving or scanning performed by a gate driver.

One scheme to resolve the interference problem is to periodically suspend the gate driving, during which touch sensing may be performed in a secure manner. The conventional gate driver is composed of, among others, a shift register that utilizes capacitors to store charges, according to which driving signals are generated. As a result, the capacitors may be discharged during the suspended period such that, while recovered from the suspended period, the charges remained in the capacitors may delay generating the driving signals or, at worst, may no longer be capable of generating driving signals.

For the reasons that conventional touch screen could not effectively solve the interference problem caused by gate driving, a need has thus arisen to propose a novel scheme to overcome the interference problem without scarifying the functions of a gate driver.

### SUMMARY OF THE INVENTION

In view of the foregoing, it is an object of the embodiment of the present invention to provide a gate driver with inactive latches disposed between adjacent active latches for providing inactive periods reserved exclusively for performing touch sensing.

According to one embodiment, a shift register adaptable to a gate driver includes a plurality of active latches and a plurality of inactive latches. The active latches and the inactive latches are connected in cascade such that each except the first and the last of the active/inactive latches turns on in response to an output signal of a preceding one of the active/inactive latches, and turns off in response to an output signal of a succeeding one of the active/inactive latches. At least one inactive latch is disposed between two adjacent active latches, and each said active latch has its output signal configured as a gate control signal to control a display panel, while an output signal of each said inactive latch is not coupled to the display panel.

### BRIEF DESCRIPTION OF THE DRAWINGS

FIG. 1 shows a block diagram illustrating a shift register of a gate driver according to one embodiment of the present invention;

FIG. 2 shows a modified shift register compared to the shift register in FIG. 1 according to a another embodiment of the present invention;

FIG. 3 shows a timing diagram in companion with the shift register of FIG. 2;

FIG. 4A shows an exemplary circuit diagram illustrated of a latch of FIG. 1 or FIG. 2; and

FIG. 4B shows an exemplary timing diagram in companion with the circuit of FIG. 4A.

### DETAILED DESCRIPTION OF THE INVENTION

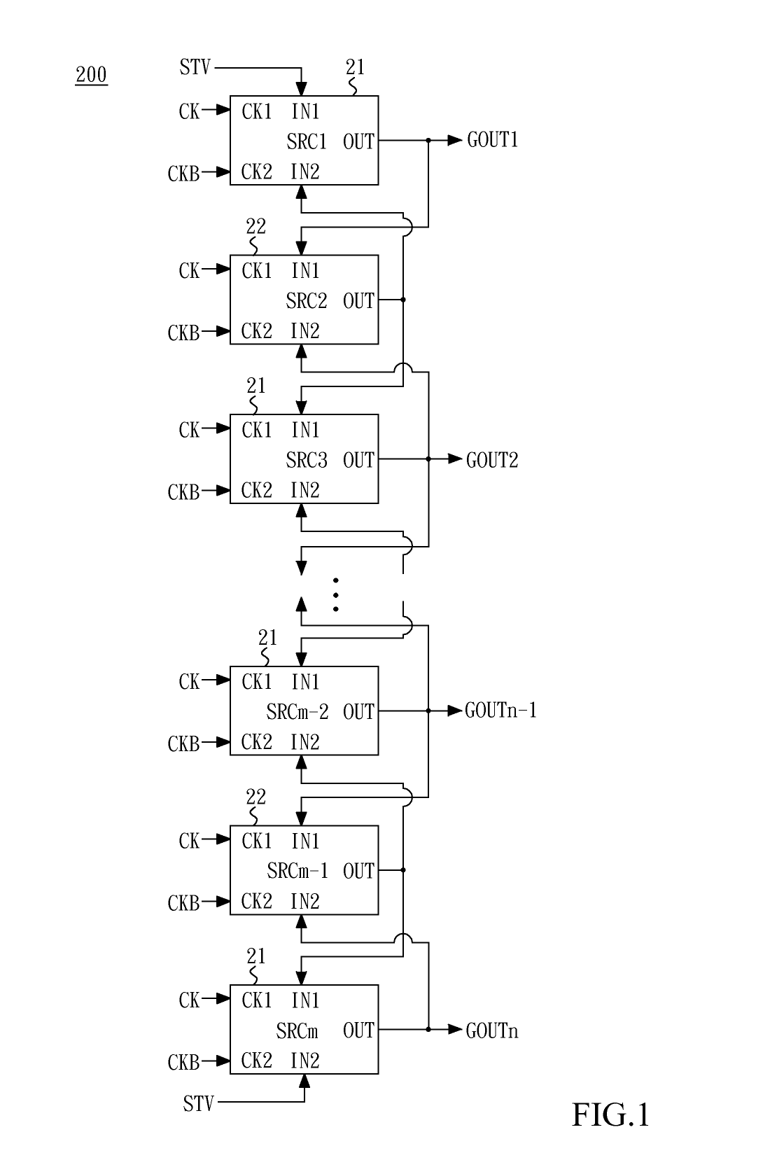

FIG. 1 shows a block diagram illustrating a shift register 200 of a gate driver according to one embodiment of the present invention. The embodiment may be adaptable to a display panel (for example, a liquid crystal display (LCD) panel) equipped with a touch panel, that is, a touch display device or touch screen. The embodiment is more preferably adaptable to an in-cell touch display device, in which the gate driving operation for the display panel may likely affect normal touch sensing for the touch panel.

In the embodiment, the shift register 200 is composed of a plurality of active latches 21 and inactive latches 22. The active/inactive latches 21/22 are connected in cascade such that each latch 21/22 turns on in response to an output signal OUT of a preceding latch 21/22, and turns off in response to an output signal OUT of a succeeding latch 21/22. For example, the latch marked as SRC2 turns on (to generate an asserted output signal OUT) when its first input node IN1 receives a de-asserted output signal OUT (e.g., from high voltage to low voltage) of the preceding latch marked as SRC1, and the same latch SRC2 thereafter turns off (to have its output signal OUT de-asserted) when its second input node IN2 receives an asserted output signal OUT (e.g., from low voltage to high voltage) of the succeeding latch marked as SRC3. It is noted that the first input node IN1 of the first latch 21/22 of the shift register 200 is coupled to receive a start signal STV (e.g., a vertical synchronization signal), and the second input node IN2 of the last latch 21/22 of the shift register 200 is coupled to receive the start signal STV. Each latch 21/22 may further include at least one clock input node coupled to receive a clock signal. In the embodiment, each latch 21/22 has a first clock input node CK1 coupled to receive a clock signal CK, and a second input node CK2 coupled to receive an inverted clock signal CKB, which has a polarity opposite to the clock signal CK.

According to one aspect of the embodiment, the constituent latches 21/22 of the shift register 200 are divided into two varieties: active latches 21 and inactive latches 22. Each active latches 21 has its output signal OUT configured as a gate control signal GOUTn (n=1 to n) to control the display panel, while the output signal OUT of each inactive latch 22 is not coupled to the display panel. At least one inactive latch 22 (one inactive latch is exemplified in FIG. 1) is disposed between two adjacent active latches 21. In a specific embodiment, the first latch and the last latch of the shift register 200 are active latches 21.

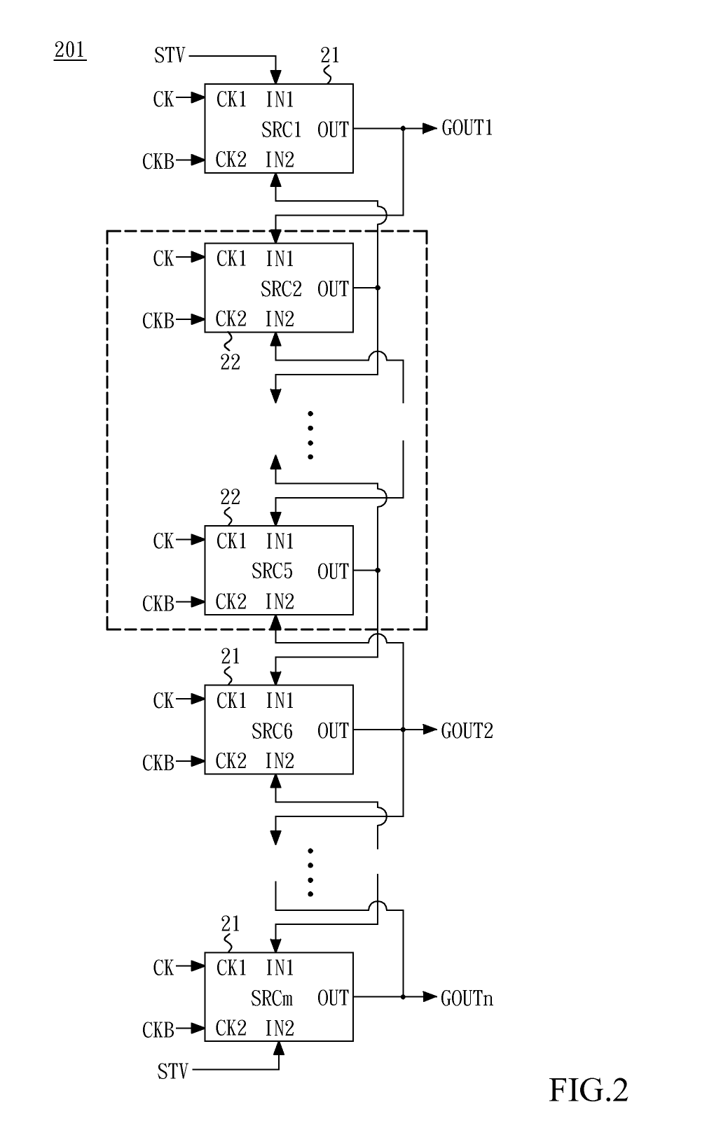

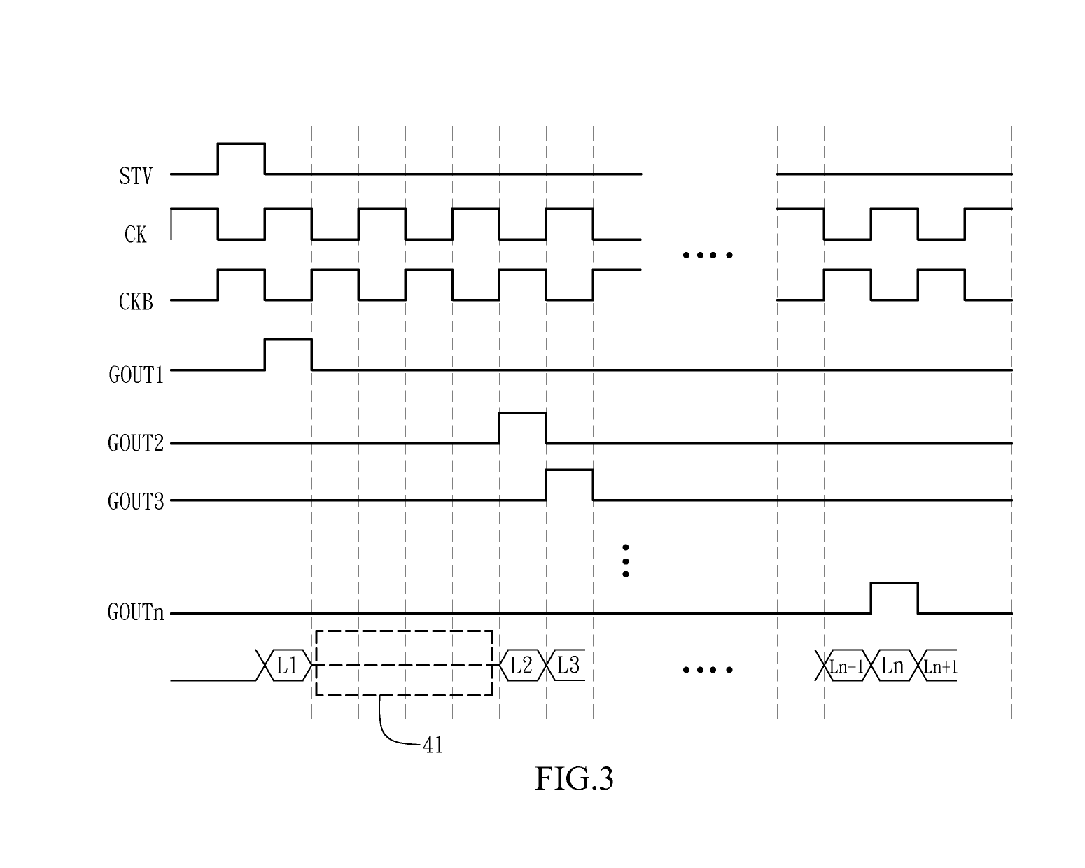

FIG. 2 shows a modified shift register 201 compared to the shift register 200 in FIG. 1 according to a another embodiment of the present invention. The shift register 201 in FIG. 2 is similar to the shift register 200 in FIG. 1, with the exception that more than one (e.g., four) inactive latches 21, as enclosed in a dashed block, are disposed (in cascade) between two adjacent active latches 21. FIG. 3 shows a timing diagram in companion with the shift register 201 of FIG. 2. As described above, no output signal OUT is retrieved from the inactive latch 22 (to the display panel), for example, in an inactive period 41, and the inactive period 41 may thus be reserved exclusively for performing touch sensing of the touch panel without concern to interference caused by gate driving operation upon the touch sensing. Generally speaking, a predetermined number of inactive latches 21 may be disposed between two adjacent active latches 21 according to requirements how long an inactive period the touch sensing need without interference caused by gate driving operation.

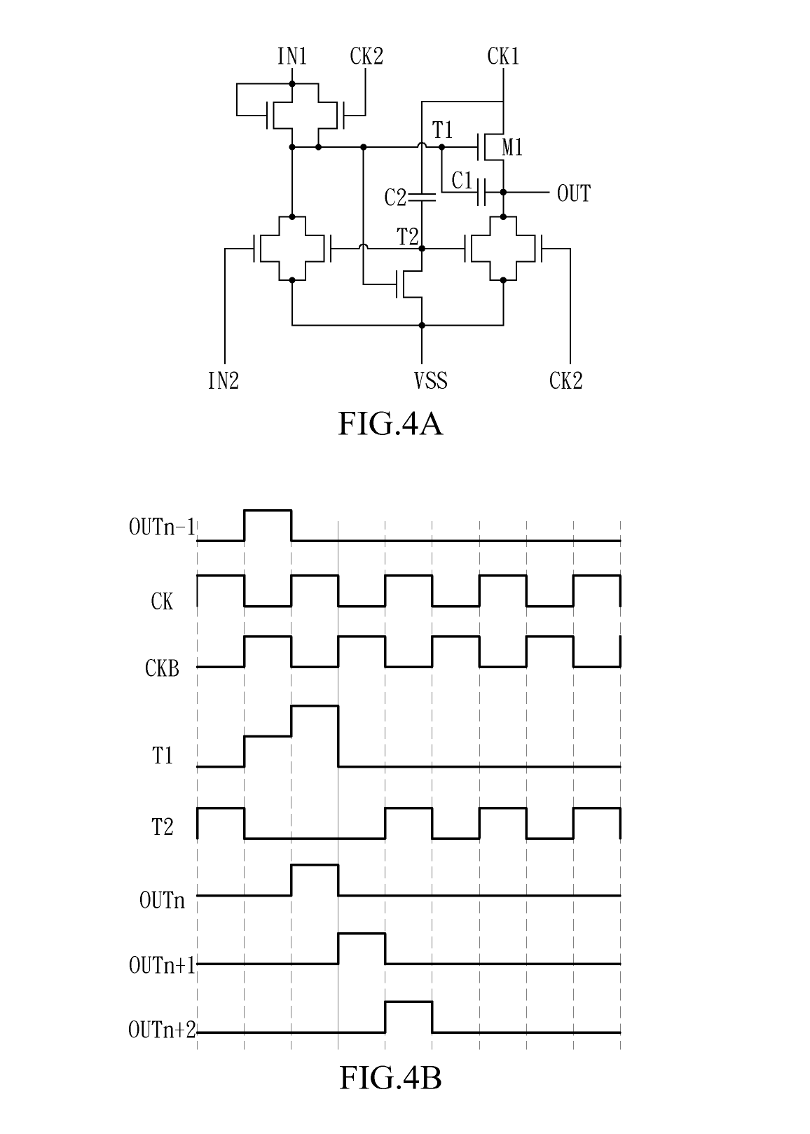

FIG. 4A shows an exemplary circuit diagram illustrated of a latch 21/22 of FIG. 1 or FIG. 2, and FIG. 4B shows an exemplary timing diagram in companion with the circuit of FIG. 4A, where OUTn represents the n-th latch 21/22 of the shift register 200/201. In the embodiment, a capacitor C1 is coupled between a gate and a source of a pull-up transistor M1 to store charge due to the preceding latch 21/22. The stored charge in the capacitor C1 will turn on the pull-transistor M1 in the next clock cycle, therefore generating an output signal OUT.

Although specific embodiments have been illustrated and described, it will be appreciated by those skilled in the art that various modifications may be made without departing from the scope of the present invention, which is intended to be limited solely by the appended claims.

What is claimed is:

1. A shift register adaptable to a gate driver, comprising:
a plurality of active latches; and
a plurality of inactive latches, the active latches and the inactive latches being connected in cascade such that each except the first and the last of the active/inactive latches turns on in response to an output signal of a preceding one of the active/inactive latches, and turns off in response to an output signal of a succeeding one of the active/inactive latches;
wherein at least one inactive latch is disposed between two adjacent active latches, and each said active latch has its output signal configured as a gate control signal to control a display panel, while an output signal of each said inactive latch is not coupled to the display panel.

2. The shift register of claim 1, wherein each except the first and the last of the active/inactive latches comprises:
a first input node coupled to receive the output signal of the preceding one of the active/inactive latches; and
a second input node coupled to receive the output signal of the succeeding one of the active/inactive latches.

3. The shift register of claim 2, wherein a given one except the first and the last of the active/inactive latches turns on when its first input node receives a de-asserted output signal of the preceding one of the active/inactive latches.

4. The shift register of claim 2, wherein a given one except the first and the last of the active/inactive latches turns off when its second input node receives an asserted output signal of the succeeding one of the active/inactive latches.

5. The shift register of claim 1, wherein the first of the active/inactive latches comprises:
a first input node coupled to receive a start signal; and
a second input node coupled to receive the output signal of the succeeding one of the active/inactive latches.

6. The shift register of claim 5, wherein the last of the active/inactive latches comprises:
a first input node coupled to receive the output signal of the preceding one of the active/inactive latches; and
a second input node coupled to receive the start signal.

7. The shift register of 1, wherein each of the active/inactive latches comprises at least one clock input node coupled to receive a clock signal.

8. The shift register of claim 7, wherein the at least one clock input node of each of the active/inactive latches comprises:
a first clock input node coupled to receive the clock signal; and
a second clock input node coupled to receive an inverted clock signal, which has a polarity opposite to the clock signal.

9. The shift register of claim 1, wherein the first and the last of the active/inactive latches are active latches.
